(19) United States
(12) Patent Application Publication
(10) Pub. No.: US 2013/0116973 A1
(43) Pub. Date: May 9, 2013

(54) HYPERTHREADED ANALYTICS

(71) Applicant: Charles Edgar Tackett, Chesepeake, VA (US)

(72) Inventor: Charles Edgar Tackett, Chesepeake, VA (US)

(73) Assignee: General Electric Corporation, Schenectady, NY (US)

(21) Appl. No.: 13/291,313

(22) Filed: Nov. 8, 2011

(51) Int. Cl. G06F 15/00

(52) U.S. Cl. 702/179; 702/127

(57) ABSTRACT

An apparatus monitoring system includes a plurality of sensors monitoring the operation of the apparatus; a real-time monitoring system that receives sensor data from the sensors according to a periodic sensor data time; and a non-real-time analysis system periodically receiving a collection of the sensor data from the real-time monitoring system. The non-real-time analysis system analyzes a plurality of the collections over a time greater than the periodic sensor data time and provides the results of the analysis to the real-time monitoring system during a subsequent periodic sensor data time. The real-time monitoring system outputs a combination of the sensor data and the analysis results according to the periodic sensor data time.

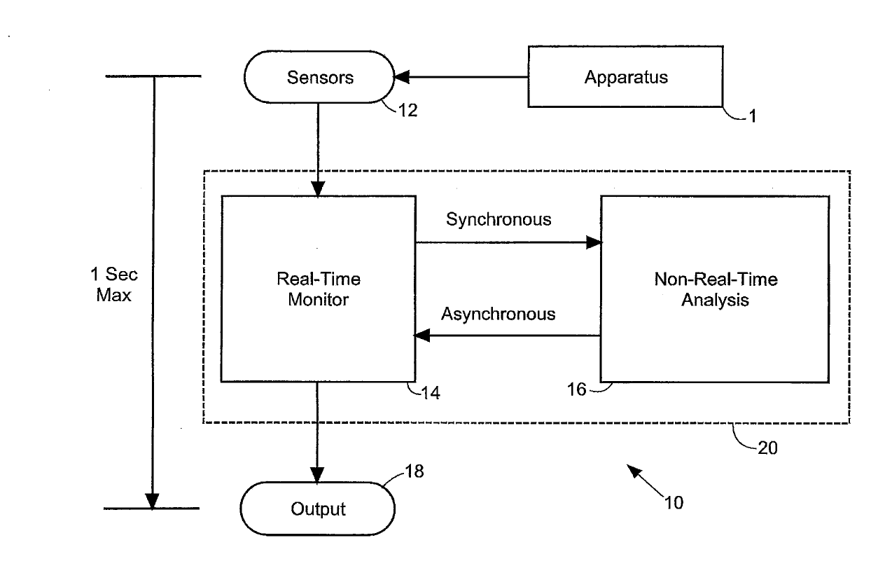

### BACKGROUND OF THE INVENTION

1. Field of the Invention

The present invention relates to apparatus monitoring systems, and specifically relates to real-time monitoring systems.

2. Discussion of the Prior Art

Real-time monitoring systems are increasingly common and becoming more complex. Many such systems have some periodic time period in which data are gathered from various sensors associated with the operation of the apparatus and various processing is performed. Typically, such a system will be considered real-time if it is able to receive the desired sensor data and provide monitoring outputs related thereto within the periodic sensor data time. As the number of sensors increase and/or the level of data processing increases, it becomes more difficult to accomplish all of the desired data acquisition, processing and monitoring output within the periodic sensor data time.

### BRIEF DESCRIPTION OF THE INVENTION

The following summary presents a simplified summary in order to provide a basic understanding of some aspects of the apparatus and/or methods discussed herein. This summary is not an extensive overview of the apparatus and/or methods discussed herein. It is not intended to identify key/critical elements or to delineate the scope of such apparatus and/or methods. Its sole purpose is to present some concepts in a simplified form as a prelude to the more detailed description that is presented later.

One aspect of the invention provides an apparatus monitoring system that includes a plurality of sensors monitoring the operation of the apparatus; a real-time monitoring system that receives sensor data from the sensors according to a periodic sensor data time; and a non-real-time analysis system periodically receiving a collection of the sensor data from the real-time monitoring system. The non-real-time analysis system analyzes a plurality of the collections over a time greater than the periodic sensor data time and provides the results of the analysis to the real-time monitoring system during a subsequent periodic sensor data time. The real-time monitoring system outputs a combination of the sensor data and the analysis results according to the periodic sensor data time.

### BRIEF DESCRIPTION OF THE DRAWINGS

The foregoing and other aspects of the invention will become apparent to those skilled in the art to which the invention relates upon reading the following description with reference to the accompanying drawings, in which the FIGURE is a block diagram of an example of a monitoring system according to an aspect of the invention.

### DETAILED DESCRIPTION OF THE INVENTION

Referring to the FIGURE, an apparatus monitoring system 10 for an apparatus 1 includes sensors 12, a real-time monitoring system 14, a non-real-time analysis system 16 and a monitoring output 18.

The sensors 12 monitor the operation of the apparatus 1. Examples of a possible monitored apparatus include: turbines, generators, motors, fans, pumps, boilers, heat exchangers, compressors, and internal-combustion engines. The sensors 12 may include sensors that sense, for example, temperature, pressure, rotation, displacement, stress/strain, torsion, time, flexure, electrical parameters, and chemical parameters.

The real-time monitoring system 14 receives inputs from the sensors 12 and provides monitoring output 18 reflecting the operation/status of the apparatus 1. The monitoring output 18 may include, for example, the sensor input data, as well as values calculated from the input sensors, desired alarms and other information discussed below. The real-time monitoring system 14 is real-time in that it receives the desired sensor data and provides monitoring outputs related thereto within a periodic sensor data time. For example, as shown in the figure, this time may be one second (or equivalently, a 1 Hz rate). Shorter or longer periodic sensor times may be chosen as appropriate for a particular apparatus.

The periodic sensor data time places constraints on the level of data processing that can be performed by the real-time monitoring system 14 and still remain within the periodic sensor data time window for providing the monitoring output 18. As the number of sensors 12 increase, the amount of time the real-time monitoring system can devote to each sensor 12 typically decreases. In addition, the level of analysis that the real-time monitoring system can fit in the periodic sensor data time is typically reduced.

The non-real-time analysis system 16 receives data from the real-time monitoring system 14 in a synchronous manner. The non-real-time analysis system 16 receives data from the real-time monitoring system 14 according to the periodic sensor data time. For example, the non-real-time analysis system 16 receives a collection of all or part of the sensor data from the sensors 12. The non-real-time analysis system 16 may provide different forms of analysis. For example, it may provide historical statistical analysis, multivariate analysis, probability analysis and bad sensor detection.

The non-real-time analysis system 16 is then free to devote the needed time to perform desired time-consuming analysis functions without the constraint of the periodic sensor data time. When the desired analysis is available, the non-real-time analysis system 16 provides the analysis results to the real-time monitoring system 14 for inclusion in a combination of the current sensor data and the analysis results for output to the monitoring output 18.

Often, it is expected that the non-real-time analysis system 16 will require a time greater than the periodic data sensor time in which to perform the desired analysis. Because of this, the flow of data from the non-real-time analysis system 16 to the real-time monitoring system 14 is considered asynchronous. Once the analysis is complete, the results can be sent to the real-time monitoring system 14 during the next periodic sensor data time. An example of an advantage of this arrangement is that offloading analysis to the non-real-time analysis system 16 gives the real-time monitoring system 14 more capacity for real-time activities. For example, additional sensors 12 and/or apparatuses 1 can be accommodated.

An example of an implementation of the apparatus monitoring system 10 is the use of a general purpose computing system such as commonly referred to as a PC (personal computer) programmed to operate as described. In particular, a PC with multithreading 20 can be used. One thread is used to operate the real-time monitoring system 14 and another thread is used to operate the non-real-time analysis system 16. The PC may have, for example, separate microprocessors for each thread, a single microprocessor with separate cores for each thread, or a single processor with hyper-threading on a single core such as found on some processors sold by Intel Corporation.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An apparatus monitoring system for monitoring an apparatus, said system comprising:
a plurality of sensors monitoring the operation of said apparatus;
a real-time monitoring system, said real-time monitoring system receiving sensor data from said sensors according to a periodic sensor data time; and
a non-real-time analysis system, said non-real-time analysis system periodically receiving a collection of said sensor data from said real-time monitoring system, said non-real-time analysis system analyzing a plurality of said collections over a time greater than said periodic sensor data time and providing the results of the analysis to the real-time monitoring system during a subsequent periodic sensor data time, said real-time monitoring system outputting a combination of said sensor data and the analysis results according to said periodic sensor data time.

2. An apparatus monitoring system according to claim 1, further comprising a multithreaded microprocessor, said real-time monitoring system utilizing one thread of said microprocessor and said non-real-time analysis system utilizing a second thread of said microprocessor.

3. An apparatus monitoring system according to claim 1, wherein said analyzing includes at least one of historical statistical analysis, multivariate analysis, probability analysis and bad sensor detection.
